(19) United States
(12) Patent Application Publication
(10) Pub. No.: US 2026/0369171 A1
(43) Pub. Date: Nov. 19, 2026

(54) WEATHER-AWARE AIRCRAFT ROUTING SYSTEM AND/OR METHOD

(71) Applicant: Merlin Labs, Inc., Boston, MA (US)

(72) Inventor: Moslem Kazemi, Boston, MA (US)

(21) Appl. No.: 19/682,213

(22) Filed: May 19, 2026

Related U.S. Application Data
(60) Provisional application No. 63/808,113, filed on May 19, 2025.

(51) Int. Cl. G08G 5/34; G08G 5/76

(52) U.S. Cl. CPC G08G 5/34; G08G 5/76

(57) ABSTRACT

The method can include: receiving a set of inputs, determining a costmap based on the set of inputs, determining a route based on the costmap, determining a set of instructions for the aircraft based on the route; and optionally controlling the aircraft based on the set of instructions. However, the method can additionally or alternatively include any other suitable set of elements. The method functions to enable real-time, weather-aware routing of an aircraft from a current location toward a destination (e.g., a final destination, a next waypoint, a next feasible waypoint along an original flight path; etc.).

### CROSS REFERENCE TO RELATED APPLICATIONS

This application claims the benefit of U.S. Provisional Application No. 63/808,113 filed 19-MAY-2025 which is incorporated herein in its entirety by this reference.

### TECHNICAL FIELD

This invention relates generally to the aircraft routing field, and more specifically to a new and useful weather-aware aircraft routing system and/or method in the aircraft routing field.

### BRIEF DESCRIPTION OF THE FIGURES

FIG. 1 is a schematic representation of an example of the weather-aware aircraft routing system.

FIG. 2 is a flowchart representation of an example of the weather-aware aircraft routing method.

FIG. 3 is a schematic representation of an illustrative example of the weather-aware aircraft routing system implementing an A* grid-based routing approach.

FIG. 4A is an example representation of an operational region depicting NEXRAD weather data, a current aircraft position, and a target waypoint.

FIG. 4B is an example representation of a costmap and a set of candidate routes generated for the operational region of FIG. 4A.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. Overview.

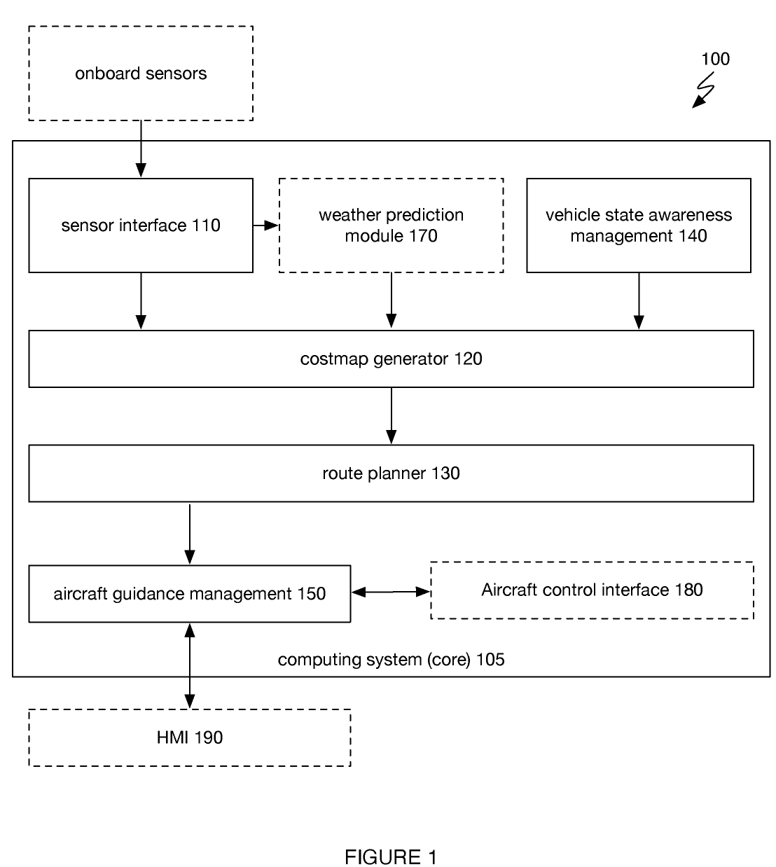

The weather-aware aircraft routing system 100, an example of which is shown in FIG. 1, can include: a sensor interface 110, a costmap generator 120, a route planner 130, a vehicle state manager 140, a routing instruction generator 150, and a computing system 105. The system can optionally include: a weather prediction module 170, an aircraft control interface 180, and/or a human machine interface (HMI) 190. However, the weather-aware aircraft routing system 100 can additionally or alternatively include any other suitable set of components. The system functions to determine and execute aircraft flight routes that account for current and/or predicted weather conditions. Additionally or alternatively, the system can function to facilitate dynamic re-routing of an aircraft in response to evolving weather conditions, sensor data updates, and/or aircraft state changes.

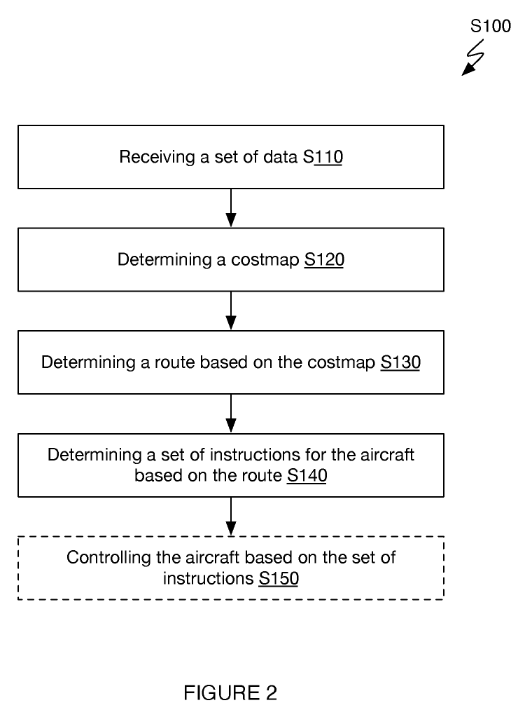

The method S100, an example of which is shown in FIG. 2, can include: receiving a set of inputs S110, determining a costmap based on the set of inputs S120, determining a route based on the costmap S130, determining a set of instructions for the aircraft based on the route S140; and optionally controlling the aircraft based on the set of instructions S150. However, the method can additionally or alternatively include any other suitable set of elements. The method functions to enable real-time, weather-aware routing of an aircraft from a current location toward a destination (e.g., a final destination, a next waypoint, a next feasible waypoint along an original flight path; etc.). The method can be repeated for different planning cycles, different aircraft, and/or otherwise repeated.

### 1.1. System Variants.

In a first variant, the system can be integrated into an autonomous aircraft system (e.g., as a component of a broader autonomous flight management capability), such as those described in U.S. Application Serial Number 17/500,358, filed 13-OCT-2021, U.S. Application Serial Number 17/891,845, filed 19-AUG-2022, and U.S. Application Serial Number 18/423,149, filed 25-JAN-2024, each of which is incorporated herein in its entirety by this reference. In this variant, the system can leverage existing avionics, flight management system infrastructure, and/or vehicle state management infrastructure of the autonomous aircraft.

In a second variant, non-exclusive with the first set, the system can be implemented as a standalone advisory device (e.g., a portable bring-aboard tablet device, an iPad-based application, a display, etc.) that provides weather routing advisories to a pilot of an existing aircraft (e.g., a conventionally-piloted aircraft, a retrofit application, etc.). In this variant, the system preferably operates in an advisory mode wherein routing recommendations are presented to a pilot via a human machine interface, but can additionally or alternatively operate in a pilot-on-the-loop mode (e.g., where the system makes routing decisions unless a pilot intervenes), and/or any other suitable operational mode.

In a third variant, non-exclusive with the first or second sets, the system can be implemented as a third-party application that integrates with various aircraft types and/or operational requirements (e.g., commercial aircraft, military aircraft, unmanned aerial vehicles, etc.). However, the system can be otherwise suitably deployed.

### 1.2. Method Variants.

In a first variant, the method can determine the route using an A* grid-based search algorithm operating over the costmap.

In a second variant, non-exclusive with the first, the method can determine the route using a D* (Dynamic A*) algorithm, which can facilitate route updates in dynamic environments with changing conditions, and/or which may reduce computational cost when re-planning is required as new weather data is received.

In a third variant, non-exclusive with the first or second, the method can determine the route using a Field D* algorithm and/or any other any-angle planner, which can facilitate route generation that is not constrained to cardinal and diagonal directions of a grid (e.g., 8-neighbor connectivity), and which may reduce zigzagging behavior, frequent heading changes, and/or sub-optimal trajectories that can otherwise result from greedy grid-based search.

In a fourth variant, non-exclusive with any of the above, the method can be implemented within a receding horizon framework (e.g., a model predictive control or ’MPC’ framework), wherein the costmap is updated, a new route is generated, and a portion of the route is executed within each planning cycle. However, the method can be otherwise suitably configured.

In variants, a method for weather-based routing of an aircraft comprising: periodically receiving a timeseries of historic weather data and, in response, determining a current costmap based on the timeseries of historic weather data, wherein the costmap comprises a prediction for a current timestep; responsive to determining the current costmap, generating at least one candidate route based on the costmap and an aircraft state of the current timestep, the aircraft state comprising a current route; based on a comparison of the at least one candidate route to the current route, determining a set of instructions for aircraft navigation; presenting the set of instructions to a pilot for validation; and responsive to pilot validation of the set of instructions, updating the current route and controlling the aircraft based on the set of instructions.

In variants, a method for weather-based routing of an aircraft, the method comprising: while the aircraft is navigating along a predetermined route comprising a set of waypoints, receiving an aircraft state and a set of weather data comprising NEXRAD data; using a learned model, determining a costmap based on the set of weather data; with a receding horizon control framework, generating a candidate route based on the costmap, the at least one waypoint, and the aircraft state; based on a comparison of the candidate route to the predetermined route, selecting the candidate route and determining a set of instructions for aircraft navigation along the candidate route; and performing an action on the aircraft based on the set of instructions.

### 1.3. Term Definitions.

The term “costmap” as utilized herein can mean: a discretized representation of an operational space (e.g., a 2-dimensional grid, a 2.5-dimensional grid, a 3-dimensional grid, etc.) wherein each cell, voxel, and/or sub-region is associated with a scalar cost value reflecting a relative desirability of traversing that cell, voxel, and/or sub-region; a continuous cost field over an operational space; and/or have any other suitable meaning.

The term “weather data” as utilized herein can mean: NEXRAD radar data, onboard weather radar data, icing condition data, thunderstorm tracking data, humidity measurement data, wind data, precipitation data, temperature data, pilot reports, weather forecast data, and/or any other suitable data type characterizing atmospheric conditions.

The term “substantially” as utilized herein can mean: exactly, approximately, within a predetermined threshold or tolerance, and/or have any other suitable meaning.

### 2. Benefits.

Variations of the technology can afford several benefits and/or advantages.

First, variations of this technology can enable real-time, weather-aware route optimization for autonomous and/or semi-autonomous aircraft, particularly under conditions in which existing aviation weather routing approaches lack AI-driven, real-time optimization capabilities. By generating and updating routes within a receding horizon framework that consumes both current and predicted weather conditions, variations of this technology can dynamically adjust routing in response to evolving weather, which may otherwise require pilot intervention or pre-flight static planning that becomes stale once weather conditions change.

Second, variations of this technology can mitigate limitations associated with NEXRAD data latency and global characteristics, which may otherwise cause routing systems to miss critical local weather changes. NEXRAD data exhibits delays of approximately 6-7 minutes between actual atmospheric conditions and data availability, and is updated approximately every 6-8 minutes. Variations of this technology can address these limitations through fusion of NEXRAD data with onboard sensor data of higher temporal resolution, through predictive modeling that estimates weather conditions during the NEXRAD update interval, and/or through filling of onboard radar shadow zones (i.e., blind spots beyond detection range or behind weather formations) using NEXRAD data, which can yield a more complete weather picture than either data source alone.

Third, variations of this technology can address aviation-specific operational constraints that general autonomous navigation approaches do not adequately handle. For example, variations of this technology can incorporate altitude management practices (e.g., maintaining consistent flight levels under typical aviation operations), Air Traffic Control (ATC) integration (e.g., handling ATC commands and clearances as overrides to autonomous routing decisions), restricted airspace handling (e.g., assigning very high cost values to prohibited zones to route around them while maintaining the optimization framework), and/or traffic collision avoidance system integration (e.g., handling ACAS/TCAS resolution advisories outside the cost planning system but reflecting them in subsequent aircraft state updates).

Fourth, variations of this technology can support adaptive planning horizons that are tuned based on weather prediction confidence, which can improve robustness and responsiveness trade-offs particularly when compared to fixed-horizon approaches. Longer horizons can provide stability and reduce frequent heading changes but may become vulnerable to prediction errors in uncertain conditions; shorter horizons can maintain robustness to changes but may miss optimization opportunities. By dynamically adjusting horizon length based on weather prediction confidence (e.g., extending the horizon when conditions are highly predictable such as clear conditions extending 100+ miles, and shortening the horizon when conditions are uncertain or rapidly changing), variations of this technology can balance these trade-offs in a context-dependent manner.

Fifth, variations of this technology can support flexible deployment across multiple aircraft platforms and operational contexts, particularly when compared to approaches that are tightly coupled to a specific aircraft architecture. For example, the same routing technology can be deployed as a component of an autonomous flight management system, as a standalone advisory tool on a portable device, and/or as a third-party application integrated with conventional aircraft, which can facilitate broader market penetration and/or use across mixed fleets.

Sixth, variations of this technology can mitigate frequent heading changes that may otherwise result from greedy grid-based search, which may otherwise overburden ATC under Instrument Flight Rules (IFR) operation (where each route deviation requires ATC communication and approval) and/or generate flight paths that are not pilot-acceptable. Variations of this technology can mitigate such heading changes through any-angle planning (e.g., Field D*), through threshold-based heading-change decisions wherein a heading change is implemented only when a sufficient cost reduction is achieved, through post-processing smoothing and shortcutting of an initial route, and/or through extension of the planning horizon under conditions of high prediction confidence.

Seventh, variations of this technology can leverage navigation cost functions learned from human pilot demonstrations (e.g., via imitation learning), which can yield routes that approximate the routing decisions a human pilot would make given the same weather information, particularly when compared to manually-tuned cost functions, which can be time intensive to develop, slow to execute, and yield inaccurate results in operational conditions outside the tuned operating envelope.

However, variations of the technology can additionally or alternatively provide any other suitable benefits and/or advantages.

### 3. System.

The weather-aware aircraft routing system 100, an example of which is shown in FIG. 1, can include: a sensor interface 110, a costmap generator 120, a route planner 130, a vehicle state manager 140, a routing instruction generator 150, and a computing system 105. The system can optionally include: a weather prediction module 170, an aircraft control interface 180, and/or a human machine interface (HMI) 190. However, the weather-aware aircraft routing system 100 can additionally or alternatively include any other suitable set of components. The system functions to determine and execute aircraft flight routes that account for current and/or predicted weather conditions.

In a first set of variants, the system can be configured for integration with an autonomous aircraft (e.g., as part of an autonomous flight management capability), wherein the system shares avionics infrastructure, vehicle state data, and/or computing resources with the autonomous aircraft.

In a second set of variants, non-exclusive with the first, the system can be configured as a standalone advisory device (e.g., a portable tablet, a kneeboard-mounted display, etc.) wherein the system communicates with one or more onboard or external sensors via wired and/or wireless data links and presents routing advisories via the human machine interface.

In a third set of variants, non-exclusive with the first or second, the system can be configured for integration with third-party aircraft systems via standardized data interfaces (e.g., ARINC 429, ARINC 664/AFDX, MIL-STD-1553, Ethernet, and/or any other suitable avionics data bus). However, the system can be otherwise suitably configured.

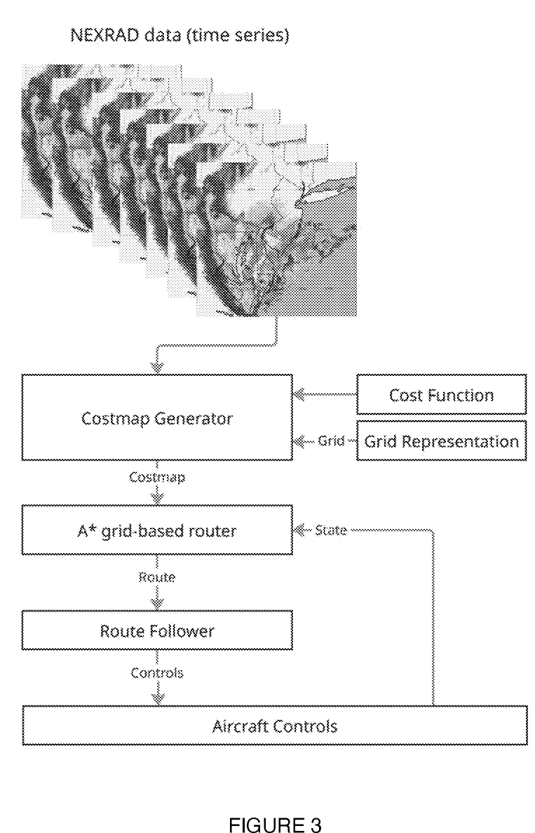

In an illustrative example, an example of which is shown in FIG. 3, the system 100 can be configured to: receive a time series of NEXRAD radar data; pass the time series to the costmap generator 120 along with a cost function and a grid representation; generate a costmap at the costmap generator 120; pass the costmap to the route planner 130 configured as an A* grid-based router; pass a resulting route to the routing instruction generator 150 configured as a route follower; output a set of aircraft control commands to an aircraft control interface 180; and consume aircraft state feedback (e.g., from the vehicle state manager 140) at the route planner 130 in a subsequent planning cycle. However, the system 100 can be otherwise suitably configured.

### 3.1. Sensor Interface.

The sensor interface 110 functions to receive sensor data characterizing weather conditions and/or other operational environment features. Additionally or alternatively, the sensor interface can function to time-align sensor data from heterogeneous sources (e.g., sources with different update frequencies, latencies, and/or resolutions), to filter sensor data, and/or to spatially register sensor data to a common coordinate frame.

The sensor interface preferably receives sensor data from a plurality of weather data sources, but can additionally or alternatively receive sensor data from a single source. The plurality of weather data sources preferably includes: NEXRAD radar data (e.g., received from a Next Generation Radar network operated by the National Oceanic and Atmospheric Administration, received from a third-party redistributor of NEXRAD data, received from an Amazon S3 archive of NEXRAD Level II data such as a noaa-nexrad-level2 bucket, etc.), onboard weather radar data (e.g., from an onboard X-band weather radar, from an onboard millimeter-wave weather radar, etc.), and/or any other suitable weather data source. Additionally or alternatively, the plurality of weather data sources can include: icing condition data, thunderstorm tracking data, humidity measurement data, wind data, pilot reports (PIREPs), terminal aerodrome forecasts (TAFs), Significant Meteorological Information (SIGMET), Airmen’s Meteorological Information (AIRMET), and/or any other suitable weather information.

In a first variant, the sensor interface can superimpose NEXRAD data and onboard radar data such that the onboard radar data provides high-temporal-resolution local weather information and the NEXRAD data provides broader geographic coverage of global weather patterns.

In a second variant, the sensor interface can fill onboard radar shadow zones (e.g., zones beyond a detection range of the onboard radar, zones occluded by a weather formation, etc.) using NEXRAD data and/or predicted weather data (e.g., predicted from surrounding weather patterns and/or storm movement vectors).

In a specific example, the sensor interface receives NEXRAD Level II data at an update frequency of approximately every 6-8 minutes, receives onboard weather radar data at an update frequency higher than that of the NEXRAD data (e.g., 1 Hz, 2 Hz, 5 Hz, etc.), and outputs a fused weather data product to the costmap generator at a fixed update frequency (e.g., aligned with the NEXRAD update frequency, aligned with a planning cycle frequency, etc.).

However, the system can include any other suitable sensor interface.

### 3.2. Costmap Generator.

The costmap generator 120 functions to generate a discretized cost representation of an operational space based on the sensor data (e.g., NEXRAD data) received via the sensor interface. Additionally or alternatively, the costmap generator can function to update the costmap as new sensor data is received, to extrapolate the costmap forward in time using a weather prediction model, and/or to combine multiple cost features into a scalar cost per cell.

The costmap is preferably a 2-dimensional grid corresponding to a current and/or set altitude of the aircraft, but can additionally or alternatively be a 2.5-dimensional grid (e.g., a 2D grid with altitude-dependent cost layers), a 3-dimensional grid (e.g., voxelized at multiple altitude slices corresponding to NEXRAD altitude layers), a 2D grid evaluated across different altitudes (e.g., based on a current flightplan), and/or any other suitable representation.

The costmap can be temporally structured as: a single frame (e.g., representing current conditions, representing historical conditions associated with a timestamp, etc.); a multi-frame time series (e.g., a forward-looking time series associated with a weather prediction, a sequence of NEXRAD frames captured approximately every 6 minutes, a sequence of frames extending approximately 1 hour forward in time, etc.); and/or any other suitable temporal structure.

The costmap generator preferably determines the cost per cell using a learned cost function (e.g., a navigation policy learned via imitation learning from human pilot demonstrations of routes through weather-affected regions, a deep neural network trained on labeled pilot trajectories, etc.), but can additionally or alternatively determine the cost per cell using: a manually-designed cost function (e.g., a linear weighted combination of NEXRAD intensity values), a cost function determined via supervised classification, a cost function determined via autonomous exploration and reinforcement learning, and/or any other suitable cost function. In a specific example, the costmap generator applies a learned navigation policy to map NEXRAD intensity levels at each grid cell to a scalar cost value (e.g., using a learned model, etc.)

The costmap generator can incorporate cost features beyond precipitation intensity, including: humidity, icing conditions, storm characteristics (e.g., storm intensity, storm motion vector, storm growth/decay rate, etc.), wind speed and direction, temperature gradients, terrain elevation, restricted airspace zones, no-fly zones, and/or any other suitable cost feature(s).

In a specific example, the costmap generator assigns a very high cost value (e.g., effectively prohibitive cost) to grid cells corresponding to restricted airspace zones, terrain obstacles, and/or zones associated with high-intensity weather (e.g., NEXRAD reflectivity exceeding a predefined threshold such as 40 dBZ, 50 dBZ, etc.), which can cause the route planner to route around such cells while maintaining the optimization framework.

However, the system can include any other suitable costmap generator.

### 3.3. Route Planner.

The route planner 130 functions to determine a route from a current aircraft location to a target location (e.g., a final destination, a next waypoint, a next feasible waypoint on an original flight path, a dynamically-adjusting objective along an original flight path within a prediction horizon, etc.) based on the costmap. Additionally or alternatively, the route planner can function to re-plan the route as the costmap is updated, to evaluate alternative routes, and/or to apply post-processing smoothing or shortcutting to a generated route.

The route planner preferably determines the route by minimizing an aggregate path cost computed by summing the costmap costs of cells traversed along the route and/or by combining the path cost with a heuristic estimating remaining distance to the target (e.g., a Euclidean heuristic), but can additionally or alternatively determine the route by maximizing an energy or score function, by satisfying a set of constraints (e.g., maximum heading change per unit distance, maximum total path length, etc.), and/or via any other suitable optimization formulation.

In a first variant, the route planner can implement an A* grid-based search algorithm with 8-neighbor connectivity (e.g., cardinal and diagonal directions), which can serve as a conceptual framework and/or reference implementation for grid-based cost optimization. An example of an A* grid-based router configuration of the route planner 130 is shown in FIG. 3.

In a second variant, the route planner can implement a D* (Dynamic A*) algorithm, which can facilitate efficient re-planning under dynamic environment conditions and/or incremental costmap updates.

In a third variant, the route planner can implement a Field D* algorithm and/or another any-angle planner that employs interpolation during vertex expansion to determine near-optimal paths across regular and/or non-uniform cost grids, which can enable any-angle planning beyond cardinal and diagonal directions and/or can facilitate smoother flight paths.

In a fourth variant, non-exclusive with the third, the route planner can apply post-processing to a route generated by an underlying grid-based planner, the post-processing including: smoothing operations (e.g., spline fitting, Bezier curve fitting, polynomial fitting, etc.), shortcutting operations (e.g., replacing route segments with direct shortcuts where the direct shortcut does not increase aggregate cost beyond a threshold), and/or any other suitable post-processing. Smoothed and/or shortcut routes can be re-evaluated against the costmap to verify that optimality is maintained after geometric modification.

In a fifth variant, the route planner can switch between a machine-learning-based routing approach and a programmatic (e.g., rule-based, manually-tuned) routing approach based on a runtime assurance evaluation of both approaches, which can address corner cases involving sudden large changes in weather patterns. In a specific example, a runtime assurance module evaluates a first route from the machine-learning-based approach and a second route from the programmatic approach against a set of safety constraints, and selects the route satisfying the constraints (e.g., selecting the programmatic route as a fallback when the machine-learning-based route fails the constraint check).

In a sixth variant, the route planner can implement a heading-change mitigation strategy, including: evaluating a proposed direction change against maintaining a current heading; implementing a heading change only when a cost reduction associated with the change exceeds a threshold (e.g., a fixed threshold, a threshold adapted based on operational mode such as IFR vs VFR, a threshold adapted based on prediction confidence, etc.); limiting a total number of heading changes per unit time and/or per route segment (e.g., to one to three heading changes for IFR operation to reduce ATC communication burden); and/or any other suitable heading-change mitigation strategy.

The route planner can determine the route over a planning horizon, the planning horizon being: approximately 1 hour forward, an interval aligned with a NEXRAD update period, an interval determined adaptively based on weather prediction confidence (e.g., extending the horizon when prediction confidence is high such as in clear conditions extending 100+ miles, and shortening the horizon when prediction confidence is low and/or weather is rapidly changing), and/or any other suitable planning horizon.

The route planner preferably operates within a receding horizon framework (e.g., model predictive control or ‘MPC’) wherein a new route is generated at each planning cycle based on the latest costmap and aircraft state, and only a portion of the generated route is executed before the next planning cycle, but can additionally or alternatively operate in a single-shot planning mode and/or any other suitable mode.

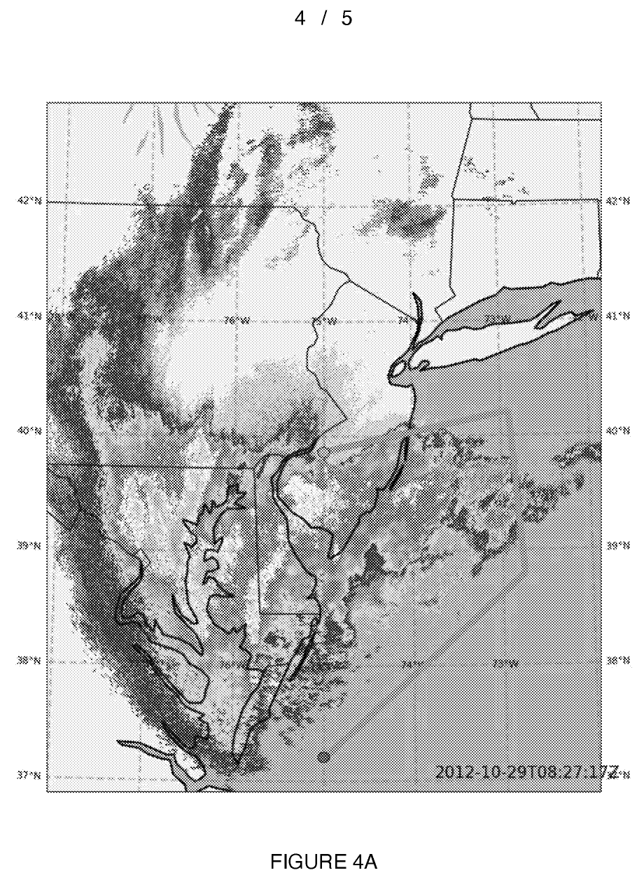

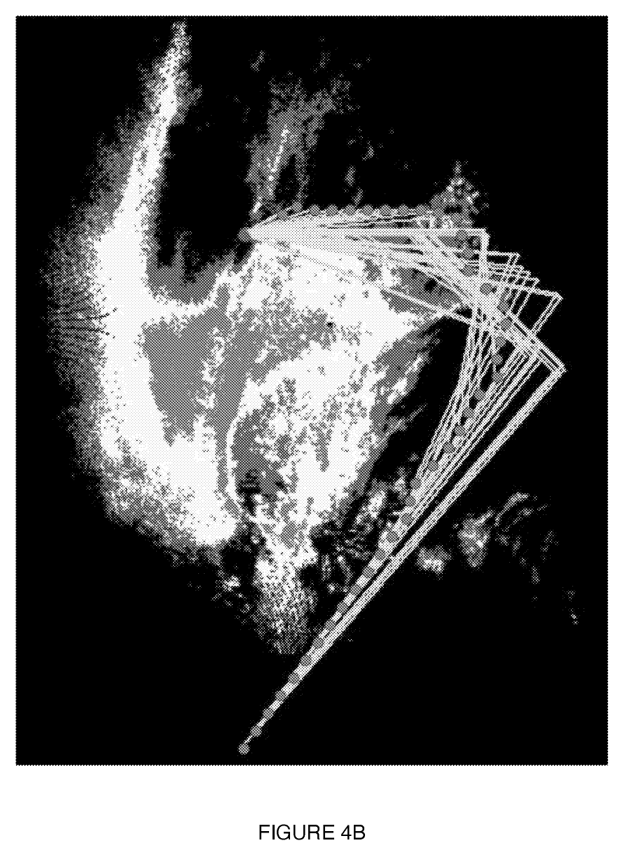

In a specific example, examples of which are shown in FIGS. 4A and 4B, the route planner 130 determines a route from a current aircraft position toward a target waypoint defining an operational region (e.g., a region characterized by NEXRAD weather data as shown in FIG. 4A), wherein the route is selected from a set of candidate routes evaluated against a costmap derived from the NEXRAD data (e.g., as shown in FIG. 4B).

However, the system can include any other suitable route planner.

### 3.4. Vehicle State Manager.

The vehicle state manager 140 functions to provide an aircraft state input to the route planner which can ensure routing plans remain consistent with actual aircraft capabilities, current operational status, and/or higher-priority safety system commands. The aircraft state can include: a current aircraft position (e.g., latitude, longitude, altitude), a current aircraft velocity (e.g., ground speed, true airspeed, vertical speed), a current heading, a current aircraft configuration (e.g., flap setting, gear position, fuel quantity), a set of operational constraints (e.g., maximum operating altitude, performance limits, fuel-based range limits, etc.), an ATC communication state (and/or context associated therewith), and/or any other suitable state information. The aircraft state can additionally or alternatively include: pending and/or active ATC clearances, pending and/or active resolution advisories from an Airborne Collision Avoidance System (ACAS) and/or Traffic Collision Avoidance System (TCAS), traffic separation requirements, and/or any other suitable command or constraint that takes precedence over weather routing decisions.

The vehicle state manager preferably updates the aircraft state at a frequency exceeding the planning cycle frequency (e.g., 1Hz, 10 Hz, 20 Hz, 50 Hz, 100 Hz, etc.; where the planning cycle may be on the order of seconds or minutes, such as in conjunction with NEXRAD updates), but can additionally or alternatively update the aircraft state at the planning cycle frequency, in response to a state-change event, and/or with any other suitable timing.

In a specific example, an ACAS/TCAS resolution advisory commanding an altitude change is handled outside the cost planning system (e.g., by a flight control system) and is reflected in a subsequent aircraft state update consumed by the route planner at the next planning cycle. In a second specific example, an ATC command and/or clearance overrides an autonomous routing decision and is incorporated into a subsequent planning cycle.

However, the system can include any other suitable vehicle state manager.

### 3.5. Routing Instruction Generator.

The routing instruction generator 150 functions to convert a weather aware optimized route from the route planner into a set of actionable aircraft guidance commands. Additionally or alternatively, the routing instruction generator can function to validate generated commands against aircraft performance characteristics and/or operational constraints, to format commands according to a target avionics interface specification, and/or to generate a set of commands for ATC communication. The set of instructions can include: a heading command, an altitude command, a velocity command, a waypoint sequence, a flight path target, a guidance bug setting, an autopilot mode selection, an ATC communication response (e.g., a request to deviate, a position report, etc.), and/or any other suitable instruction. The routing instruction generator can be implemented onboard the aircraft, offboard the aircraft (e.g., on a ground-based processing system), in a distributed manner (e.g., partially onboard and partially offboard), and/or in any other suitable processing location.

However, the system can include any other suitable routing instruction generator.

### 3.6. Weather Prediction.

The optional weather prediction module 170 functions to predict weather conditions over a forward time horizon, which can compensate for the latency of NEXRAD data and/or extend the costmap into a forward-looking time series.

The weather prediction module preferably implements a deep learning-based weather prediction model trained on multiple sensor data sources, but can additionally or alternatively implement a physics-based weather prediction model, a statistical weather prediction model, a hybrid model, and/or any other suitable model. In a specific example, the weather prediction module implements a medium-range global weather forecasting approach, adapted to a shorter prediction horizon (e.g., a next 5 minute prediction, a next 10 minute prediction, a next 30 minute prediction, etc.) suitable for immediate routing decisions.

The weather prediction module can output a confidence and/or uncertainty quantification associated with each prediction, which can be consumed by the route planner to adapt the planning horizon (e.g., extending the horizon when prediction confidence is high, shortening the horizon when prediction confidence is low).

However, the system can include any other suitable weather prediction module and/or exclude a weather prediction module.

### 3.7. Optional Aircraft Control Interface.

The optional aircraft control interface 180 functions to communicate the set of instructions from the routing instruction generator to a flight control system, an autopilot, and/or another aircraft system that effects aircraft motion.

In a first variant, the aircraft control interface can directly couple with a flight management system (FMS) and/or autopilot of an autonomous aircraft, wherein the set of instructions is consumed without pilot intervention.

In a second variant, the aircraft control interface can present the set of instructions to a pilot via the human machine interface for pilot review and/or pilot-initiated execution (e.g., in an advisory mode, in a pilot-in-the-loop mode).

In a third variant, the aircraft control interface can operate in a pilot-on-the-loop mode wherein the system makes routing decisions and effects aircraft control unless a pilot intervenes (e.g., by overriding via a control input, by selecting a manual mode, etc.).

However, the system can include any other suitable aircraft control interface and/or exclude an aircraft control interface.

### 3.8. Optional Human Machine Interface.

The system can optionally include and/or operate in conjunction with a human machine interface (HMI) 190 functions to present routing information (e.g., the costmap, the generated route, an aircraft state, weather data, predicted weather, an alert, etc.) to a pilot and/or to receive pilot input (e.g., a route acceptance, a manual override, a destination selection, a horizon selection, etc.). The HMI can include: a display (e.g., a tablet display, a multi-function display (MFD), a primary flight display (PFD), a heads-up display (HUD), a portable bring-aboard device, etc.), a control input (e.g., a touchscreen, a physical button, a knob, a voice input, etc.), an audio output, and/or any other suitable interface element. However, the system can include any other suitable human machine interface and/or exclude a human machine interface.

As an example, the system can include an HMI and/or pilot validation/verification system(s) as described in U.S. Application Serial Number 18/423,149, filed 25-JAN-2024, which is incoporporated herein in its entirety by this reference.

However, the HMI can be otherwise configured and/or the system may altogether exclude an HMI.

### 3.9. Computing System.

The system can include and/or operate in conjunction with a computing system 105 which functions to execute the system costmap generator, route planner, vehicle state manager, routing instruction generator, weather prediction module, and/or other system components. The computing system preferably includes a set of processors (e.g., CPUs, GPUs, TPUs, FPGAs, ASICs, edge inference accelerators, etc.) and a set of non-transitory computer-readable storage media storing instructions executable by the set of processors, but can additionally or alternatively include any other suitable computing hardware. The computing system can be located onboard the aircraft (e.g., in a low design assurance level configuration, in a high design assurance level configuration, etc.), offboard the aircraft (e.g., on a ground-based system, on a distributed processing system, on a cloud computing platform, etc.), and/or in a distributed configuration partitioning processing between onboard and offboard resources.

In variants, the computing system can include the computing architecture(s) as described in U.S. Application Serial Number 17/891,845, filed 19-AUG-2022, which is incorporated herein in its entirety by this reference.

However, the system can include any other suitable computing system.

In variants, the computing system and/or computing modules thereof (costmap generator, route generator) can include a set of models. The models can include classical or traditional approaches, machine learning approaches, and/or be otherwise configured. The models can include regression (e.g., linear regression, non-linear regression, logistic regression, etc.), decision tree, LSA, clustering, association rules, dimensionality reduction (e.g., PCA, t-SNE, LDA, etc.), neural networks (e.g., CNN, DNN, CAN, LSTM, RNN, encoders, decoders, deep learning models, transformers, etc.), ensemble methods, optimization methods, classification, rules, heuristics, equations (e.g., weighted equations, etc.), selection (e.g., from a library), regularization methods (e.g., ridge regression), Bayesian methods (e.g., Naiive Bayes, Markov), instance-based methods (e.g., nearest neighbor), kernel methods, support vectors (e.g., SVM, SVC, etc.), statistical methods (e.g., probability), comparison methods (e.g., matching, distance metrics, thresholds, etc.), deterministics, genetic programs, and/or any other suitable model. The models can include (e.g., be constructed using) a set of input layers, output layers, and hidden layers (e.g., connected in series, such as in a feed forward network; connected with a feedback loop between the output and the input, such as in a recurrent neural network; etc.; wherein the layer weights and/or connections can be learned through training); a set of connected convolution layers (e.g., in a CNN); a set of self-attention layers; and/or have any other suitable architecture.

Models can be trained, learned, fit, predetermined, and/or can be otherwise determined. The models can be trained or learned using: supervised learning, unsupervised learning, self-supervised learning, semi-supervised learning (e.g., positive-unlabeled learning), reinforcement learning, transfer learning, Bayesian optimization, fitting, interpolation and/or approximation (e.g., using gaussian processes), backpropagation, and/or otherwise generated. The models can be learned or trained on: labeled data (e.g., data labeled with the target label), unlabeled data, positive training sets (e.g., a set of data with true positive labels, negative training sets (e.g., a set of data with true negative labels), and/or any other suitable set of data.

Any model can optionally be validated, verified, reinforced, calibrated, or otherwise updated based on newly received, up-to-date measurements; past measurements recorded during the operating session; historic measurements recorded during past operating sessions; or be updated based on any other suitable data.

Any model can optionally be run or updated: once; at a predetermined frequency; every time the method is performed; every time an unanticipated measurement value is received; or at any other suitable frequency. Any model can optionally be run or updated: in response to determination of an actual result differing from an expected result; or at any other suitable frequency. Any model can optionally be run or updated concurrently with one or more other models, serially, at varying frequencies, or at any other suitable time.

However, the system can include any other suitable components.

### 4. Method.

The method S100, an example of which is shown in FIG. 2, can include: receiving a set of inputs S110, determining a costmap based on the set of inputs S120, determining a route based on the costmap S130, determining a set of instructions for the aircraft based on the route S140; and optionally controlling the aircraft based on the set of instructions S150. However, the method can additionally or alternatively include any other suitable elements. The method functions to enable real-time, weather-aware routing of an aircraft toward a destination using time series weather data and aircraft state data. The method can be repeated for different planning cycles, different aircraft, different planning horizons, and/or otherwise repeated with any other suitable timing/frequency.

The method is preferably performed within a receding horizon framework wherein S110 through S140 (and optionally S150) are repeated at a planning cycle frequency (e.g., aligned with a NEXRAD update frequency of approximately every 6-8 minutes, at a fixed cycle frequency, at a frequency adapted based on weather prediction confidence, at a frequency adapted based on aircraft state changes, etc.), but can additionally or alternatively be performed in a single-shot manner, in response to a triggering event (e.g., a weather alert, a pilot request, an ATC command, a sudden change in weather conditions, etc.), and/or with any other suitable timing.

### 4.1. Receiving a Set of Inputs S110.

Receiving a set of inputs S110 functions to obtain weather data, aircraft state data, and/or other inputs used by downstream method elements to evaluate route alternatives. Additionally or alternatively, S110 can function to time-align inputs from heterogeneous sources, to filter inputs, and/or to spatially register inputs to a common coordinate frame.

S110 can include: receiving NEXRAD radar data, receiving onboard sensor data, receiving aircraft state data; optionally receiving additional weather data; optionally fusing the received data; and optionally predicting forward weather conditions. However, S110 can include any other suitable elements.

The set of inputs preferably includes NEXRAD radar data providing one or more weather slices at relevant altitudes (an example of which is shown in FIG. 4A), but can additionally or alternatively include: onboard weather radar data providing local conditions, icing condition data, thunderstorm tracking data, humidity measurement data, wind data, pilot reports, and/or any other suitable input data. The set of inputs can be received: on a single occasion (e.g., for a single iteration of the method), repeatedly, periodically (e.g., aligned with a NEXRAD update frequency of approximately every 6-8 minutes), in response to availability of new data, prior to costmap generation, and/or with any other suitable timing.

In a first variant, S110 can include superimposing NEXRAD data and onboard radar data, wherein the onboard radar data provides local weather information at a higher temporal resolution than the NEXRAD data, and the NEXRAD data provides broader geographic coverage at a lower temporal resolution.

In a second variant, non-exclusive with the first, S110 can include filling onboard radar shadow zones with NEXRAD data, predicted weather data, and/or extrapolated weather data, wherein an onboard radar shadow zone is a zone beyond a detection range of the onboard radar and/or a zone occluded by an intervening weather formation.

In a third variant, non-exclusive with the first or second, S110 can include time-aligning the NEXRAD data and the onboard radar data using a common time reference (e.g., GPS time, NTP time, etc.) and/or using a predictive model that extrapolates the NEXRAD data forward in time to compensate for its 6-7 minute latency.

In a specific example, S110 includes: retrieving NEXRAD Level II data from an Amazon S3 archive (e.g., from a noaa-nexrad-level2 bucket); retrieving onboard weather radar data via an avionics data bus; retrieving aircraft state data from a vehicle state manager via an avionics data bus; predicting NEXRAD data forward by approximately 6 minutes using a deep learning weather prediction model; and outputting a fused weather data product to S120.

However, S110 can be otherwise suitably performed.

### 4.2. Determining a Costmap.

Determining a costmap based on the set of inputs S120 functions to generate a discretized cost representation of an operational space that enables route evaluation and scoring by S130. Additionally or alternatively, S120 can function to extrapolate the costmap forward in time, to combine multiple cost features into a scalar cost per cell, and/or to incorporate non-weather constraints into the costmap.

S120 preferably generates a 2-dimensional grid-based costmap at a current and/or set altitude of the aircraft, but can additionally or alternatively generate a 2.5-dimensional costmap (e.g., a 2D grid with altitude-dependent cost layers), a 3-dimensional costmap (e.g., voxelized at multiple altitude slices corresponding to NEXRAD altitude layers), a 2D costmap evaluated across different altitudes, and/or any other suitable representation.

S120 can output: a single-frame costmap (e.g., a current costmap, a historical costmap with timestamp, etc.), a multi-frame time series costmap (e.g., a forward-looking time series associated with a weather prediction, a sequence of costmaps captured approximately every 6 minutes, a sequence of costmaps extending approximately 1 hour forward, etc.), and/or any other suitable temporal structure.

S120 preferably determines the cost per cell using a learned cost function, the learned cost function being learned via imitation learning from human pilot demonstrations of routes through weather-affected regions. Under the learned cost function, the route generated by S130 is expected to approximate a route that a human pilot would plan given the same input data. Additionally or alternatively, S120 can determine the cost per cell using: a manually-designed linear weighted cost function combining a plurality of cost features, a cost function determined via supervised classification, a cost function determined via reinforcement learning, and/or any other suitable cost function.

S120 can incorporate cost features beyond NEXRAD precipitation intensity, including: humidity values, icing condition indicators, storm characteristics (e.g., storm intensity, storm motion vector, etc.), wind speed and direction, temperature gradients, terrain elevation, restricted airspace zone indicators, no-fly zone indicators, fuel efficiency cost components, operational limitation cost components, and/or any other suitable cost feature.

In a specific example, S120 assigns a very high cost value (e.g., effectively prohibitive cost) to grid cells corresponding to restricted airspace zones, terrain obstacles, and/or zones associated with NEXRAD reflectivity exceeding a predefined threshold (e.g., 40 dBZ, 50 dBZ, etc.), which can cause S130 to route around such cells while maintaining the optimization framework.

However, S120 can be otherwise suitably determined.

### 4.3. Determining a Route Based on the Costmap S130.

Determining a route based on the costmap S130 functions to generate a cost-minimizing (or alternatively, energy-maximizing or score-maximizing) path from a current aircraft location to a target location based on the costmap and the aircraft state. Additionally or alternatively, S130 can function to apply post-processing smoothing or shortcutting to the route, to evaluate alternative routes, and/or to validate the route against operational constraints.

S130 can include: receiving the costmap from S120 and the aircraft state from a vehicle state manager S131; optionally receiving constraints (e.g., restricted zone indicators, operational limitations) S132; executing a path planning algorithm over the costmap S133; optionally applying post-processing to the resulting path S134; and outputting the route to S140 S135. However, S130 can include any other suitable elements. An example of a costmap and a set of candidate routes generated by S130 is shown in FIG. 4B.

The target location can be: a final destination, a next waypoint along an original flight path, a next feasible waypoint along an original flight path, a dynamically-adjusting objective along an original flight path within a prediction horizon (e.g., wherein the objective advances concurrently with aircraft progression), and/or any other suitable target location. In a specific example, the target location is a dynamically-adjusting waypoint along an original flight path within a prediction horizon, and the target location is replaced with the final destination when the final destination falls within the prediction horizon.

In a first variant, S130 can execute an A* grid-based search algorithm with 8-neighbor connectivity over the costmap, the A* search using a Euclidean heuristic to account for remaining route length and/or to ensure faster search and shorter routes. The A* algorithm can serve as a conceptual framework and/or reference implementation for grid-based cost optimization, an example of which is shown in FIG. 3.

In a second variant, S130 can execute a D* (Dynamic A*) algorithm, which can facilitate efficient re-planning under dynamic environment conditions and/or incremental costmap updates between planning cycles.

In a third variant, S130 can execute a Field D* algorithm and/or another any-angle planner, which can determine near-optimal paths across regular and/or non-uniform cost grids using interpolation during vertex expansion. The Field D* variant can enable any-angle planning beyond cardinal and diagonal directions of an 8-neighbor grid, which can support smoother flight paths that better align with aviation operational practices.

In a fourth variant, non-exclusive with the third, S130 can apply post-processing to an initial route generated by an underlying grid-based planner, the post-processing including: smoothing operations (e.g., spline fitting, Bezier curve fitting, polynomial fitting), shortcutting operations (e.g., replacing route segments with direct shortcuts where the direct shortcut does not increase aggregate cost beyond a threshold), heading-change reduction operations, zigzag reduction operations, and/or any other suitable post-processing. Smoothed and/or shortcut routes can be re-evaluated against the costmap to verify that optimality is maintained after geometric modification.

In a fifth variant, S130 can implement a heading-change mitigation strategy, including: evaluating a proposed direction change against maintaining a current heading; implementing a heading change only when a cost reduction associated with the change exceeds a threshold; limiting a total number of heading changes per unit time and/or per route segment (e.g., to one to three heading changes for IFR operation); tuning the threshold across different planning horizons based on weather uncertainty levels (e.g., requiring a larger cost reduction to justify a heading change when prediction uncertainty is high); and/or any other suitable heading-change mitigation strategy.

In a sixth variant, S130 can implement adaptive horizon management, including: extending the planning horizon when weather prediction confidence is high (e.g., when conditions are highly predictable, when clear conditions extend 100+ miles, etc.) to provide stability and reduce frequent heading changes; shortening the planning horizon when weather prediction confidence is low (e.g., when conditions are uncertain or rapidly changing) to maintain robustness to changes; and/or otherwise adapting the planning horizon based on a confidence and/or uncertainty quantification output by a weather prediction module.

In a seventh variant, S130 can include corner case handling for sudden large changes in weather patterns, including: switching between a machine-learning-based routing approach and a programmatic routing approach based on a runtime assurance evaluation; selecting between a reactive response (e.g., immediate heading change in response to detected change) and a conservative approach (e.g., maintaining current heading and re-evaluating at the next planning cycle); and/or any other suitable corner case handling. In a specific example, a runtime assurance module evaluates a first route from the machine-learning-based approach and a second route from the programmatic approach against a set of safety constraints, and selects the route that satisfies the constraints.

In an eighth variant, S130 can be performed within a receding horizon framework wherein: a new route is generated at each planning cycle based on the latest costmap and aircraft state; only a portion of the generated route (e.g., a portion corresponding to the time interval until the next planning cycle, a portion corresponding to a fixed distance, a portion corresponding to a fixed time duration, etc.) is executed before the next planning cycle; and the planning cycle repeats until the target location is reached. The portion of the route executed per cycle can be: a portion corresponding to the duration between successive NEXRAD updates (e.g., approximately 6 minutes), a portion corresponding to a fixed distance (e.g., 1 nautical mile, 5 nautical miles, 10 nautical miles, etc.), a portion corresponding to a fixed time (e.g., 30 seconds, 1 minute, 5 minutes, etc.), any open or closed range bounded by the aforementioned values, and/or any other suitable portion.

S130 can be performed onboard the aircraft (e.g., on a low design assurance level computing platform, on a high design assurance level computing platform), offboard the aircraft (e.g., on a ground-based system, on a distributed processing system), and/or in any other suitable processing location.

However, S130 can be otherwise suitably performed.

### 4.4. Determining Aircraft Instructions.

Determining a set of instructions for the aircraft based on the route S140 functions to convert the optimized route into actionable aircraft guidance commands. Additionally or alternatively, S140 can function to validate generated commands against aircraft performance characteristics and/or operational constraints, to format commands according to a target avionics interface specification, and/or to generate one or more ATC communication messages associated with a route deviation.

The set of instructions can include: a heading command, an altitude command, a velocity command, a waypoint sequence, a flight path target, a guidance bug setting, an autopilot mode selection, a flight director command, an ATC communication message (e.g., a request to deviate, a position report, an altitude change request, etc.), and/or any other suitable instruction.

S140 can be performed onboard the aircraft, offboard the aircraft, in a distributed manner, and/or in any other suitable processing location.

In a specific example, S140 generates a heading command and a waypoint sequence based on the route, formats the commands according to an autopilot interface specification, generates an ATC deviation request message, and outputs the formatted commands to an aircraft control interface.

However, S140 can be otherwise suitably performed.

### 4.5. Optionally Controlling the Aircraft S150.

Optionally controlling the aircraft based on the set of instructions S150 functions to effect aircraft motion in accordance with the set of instructions across one or more operational modes. The optional element S150 can be performed in a fully autonomous operational mode, in an advisory operational mode, in a pilot-in-the-loop operational mode, in a pilot-on-the-loop operational mode, and/or in any other suitable operational mode.

In a first variant, S150 can include directly commanding a flight management system, an autopilot, and/or another aircraft control system based on the set of instructions, wherein the set of instructions is consumed without pilot intervention.

In a second variant, S150 can include presenting the set of instructions to a pilot via a human machine interface (e.g., on a portable bring-aboard device, on a tablet, on a multi-function display, etc.) and effecting aircraft control upon receipt of pilot acceptance and/or pilot-initiated execution.

In a third variant, S150 can include effecting aircraft control automatically while monitoring for pilot intervention (e.g., a control input override, a manual mode selection, a pilot vocal override, etc.), and yielding control to the pilot upon detection of intervention.

In a fourth variant, S150 can include integrating with safety system priority management, wherein: high-priority safety interrupts (e.g., from collision avoidance systems) take precedence over weather routing decisions; ACAS/TCAS resolution advisories typically commanding altitude changes are handled outside the cost planning system but reflected in subsequent aircraft state updates consumed by S110 at the next planning cycle; ATC commands and clearances override autonomous routing decisions and are incorporated into a subsequent planning cycle without delay; traffic separation requirements are integrated through aircraft state management rather than direct cost function modification (e.g., to maintain modularity between safety-critical systems and the weather routing optimization); and/or priority management ensures safety-critical systems maintain authority over weather routing optimization in all operational scenarios.

S150 can be performed: continuously, periodically, in response to receipt of the set of instructions from S140, in response to a pilot input, and/or with any other suitable timing.

However, S150 can be otherwise suitably performed.

However, the weather-aware aircraft routing method can include any other suitable elements.

### 5. Additional Variants

Variations of the system and method can include a weather prediction component that addresses NEXRAD limitations through learned models. The weather prediction component preferably implements a deep learning approach processing multiple sensor data sources, but can additionally or alternatively implement a physics-based approach, a statistical approach, a hybrid approach, and/or any other suitable approach. The weather prediction horizon can be: approximately 5 minutes (e.g., for immediate routing decisions), approximately 10 minutes, approximately 30 minutes, approximately 1 hour, any open or closed range bounded by the aforementioned values, and/or any other suitable horizon.

In a specific example, the weather prediction component implements a learned model trained for medium-range global weather forecasting, adapted to a shorter-horizon nowcasting problem with high sensitivity to local, short-horizon weather changes.

Variations of the system and method can extend a 2D planning implementation to a 3D planning implementation. In variants, the 3D planning implementation can include: handling multiple altitude slices from NEXRAD data layers; evaluating altitude changes and associated weather conditions at each candidate altitude; routing across altitude transitions subject to aviation-specific altitude change limitations; and/or any other suitable 3D planning capability. The 3D planning implementation can use any of the planning algorithms described herein (e.g., A*, D*, Field D*) generalized to a 3D grid, voxelized space, and/or other 3D representation.

Variations of the system and method can integrate aviation-specific constraints, including: altitude change limitations (e.g., reflecting typical aviation operations that maintain consistent flight levels), restricted airspace zones (e.g., incorporated through high-cost assignment in the costmap), resolution advisory handling (e.g., from traffic collision avoidance systems prioritizing altitude changes over heading modifications), terminal area procedures, terrain avoidance, fuel efficiency, operational limitations, and/or any other suitable aviation-specific constraint.

Variations of the system and method can leverage uncertainty quantification from a weather prediction model to drive adaptive planning horizons. In a first example, weather prediction confidence determines a planning time horizon, with higher confidence enabling longer-range planning and reduced heading changes. In a second example, lower confidence requires shorter horizons with increased responsiveness to changing conditions. In a specific example, the planning horizon can be set as a function of a confidence score output by the weather prediction model (e.g., a linear function, a piecewise function, a learned function, etc.), bounded by a minimum horizon (e.g., 5 minutes, 10 minutes, etc.) and a maximum horizon (e.g., 1 hour, 2 hours, etc.).

Variations of the system and method can optimize the cost function for pilot acceptance and/or operational deployment requirements, including: oscillation reduction (e.g., preventing excessive heading changes through threshold-based decision making); pilot-acceptable routing patterns (e.g., following aviation operational norms regarding heading change frequency); routing logic that provides shortcuts only when significant time savings is achieved (e.g., requiring a minimum percentage time savings or distance savings to justify a deviation); and/or any other suitable optimization objective.

Variations of the system and method can implement a sensor fusion architecture combining multiple weather information sources, including: NEXRAD providing global coverage with 6-7 minute delays; onboard weather radar providing immediate local conditions with limited range; icing condition data; humidity measurement data; thunderstorm tracking data; pilot reports; terminal aerodrome forecasts; and/or any other suitable weather information source. The sensor fusion architecture can apply: weighted averaging of overlapping data sources (e.g., weighted by source reliability, by recency, by spatial proximity, etc.); priority-based selection (e.g., preferring onboard radar data within its detection range and falling back to NEXRAD data outside that range); learned fusion (e.g., a neural network trained to fuse heterogeneous weather data); and/or any other suitable fusion approach.

However, variants can be otherwise configured.

Variations of the technology described herein, including but not limited to the system 100 and method elements S110-S150, can be implemented and/or otherwise utilized in any suitable order, with any suitable timing, and/or with any suitable combination of components and elements. The system and method can be applied to: autonomous fixed-wing aircraft, autonomous rotary-wing aircraft, semi-autonomous aircraft, conventionally-piloted aircraft with advisory routing, unmanned aerial vehicles, urban air mobility (UAM) vehicles, and/or any other suitable aircraft type.

However, the weather-aware aircraft routing system and method can include any other suitable components and/or elements.

All references cited herein are incorporated by reference in their entirety, except to the extent that the incorporated material is inconsistent with the express disclosure herein, in which case the language in this disclosure controls.

As used herein, "substantially" or other words of approximation can be within a predetermined error threshold or tolerance of a metric, component, or other reference, and/or be otherwise interpreted.

Optional elements, which can be included in some variants but not others, are indicated in broken line in the figures.

Different subsystems and/or modules discussed above can be operated and controlled by the same or different entities. In the latter variants, different subsystems can communicate via: APIs (e.g., using API requests and responses, API keys, etc.), requests, and/or other communication channels. Communications between systems can be encrypted (e.g., using symmetric or asymmetric keys), signed, and/or otherwise authenticated or authorized.

Alternative embodiments implement the above methods and/or processing modules in non-transitory computer-readable media, storing computer-readable instructions that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the following system and/or method can be used with, in addition to, in lieu of, or otherwise integrated with all or a portion of the systems and/or methods disclosed in the applications mentioned above, each of which are incorporated in their entirety by this reference.

As a person skilled in the art will recognize from the previous detailed description and from the figures and claims, modifications and changes can be made to the preferred embodiments of the invention without departing from the scope of this invention defined in the following claims.

We claim:

1. A method for weather-based routing of an aircraft, the method comprising:
while the aircraft is navigating along a predetermined route comprising a set of waypoints, receiving an aircraft state and a set of weather data comprising NEXRAD data;
using a learned model, determining a costmap based on the set of weather data;
with a receding horizon control framework, generating a candidate route based on the costmap, the at least one waypoint, and the aircraft state;
based on a comparison of the candidate route to the predetermined route, selecting the candidate route and determining a set of instructions for aircraft navigation along the candidate route; and
performing an action on the aircraft based on the set of instructions.

2. The method of claim 1, wherein generating a candidate route is performed periodically in response to receipt of updated NEXRAD data.

3. The method of claim 1, further comprising: determining an uncertainty parameter associated with the costmap and dynamically selecting the at least one waypoint based on an uncertainty parameter associated with the costmap.

4. The method of claim 1, wherein the at least one waypoint is determined based on a dynamic planning horizon.

5. The method of claim 4, further comprising: using a weather prediction model, determining a prediction confidence score for the costmap, wherein the dynamic planning horizon is based on the prediction confidence score.

6. The method of claim 1, wherein the candidate route is generated using a Field D-Star (Field D*) algorithm.

7. The method of claim 6, wherein the candidate route is further generated based on a smoothing objective to reduce changes in a control parameter.

8. The method of claim 7, wherein the control parameter comprises aircraft heading.

9. The method of claim 8, wherein the costmap is determined based on the current altitude and comprises a 2D grid corresponding to a current altitude.

10. The method of claim 7, wherein the control parameter comprises an aircraft altitude, wherein the costmap comprises a 3D voxel grid.

11. The method of claim 1, wherein the costmap comprises a set of voxels along an altitude profile of the predetermined route.

12. The method of claim 1, wherein performing an action comprises presenting the set of instructions to a pilot for validation.

13. The method of claim 12, further comprising: in response to pilot validation of the set of instructions, automatically requesting an ATC clearance based on the set of instructions.

14. The method of claim 1, wherein performing an action comprises automatically controlling the aircraft based on the set of instructions.

15. The method of claim 1, wherein the costmap is determined for at least a current timestep, wherein the NEXRAD data is offset from the current timestep by at least one minute.

16. The method of claim 1, wherein the costmap and the candidate route are determined at a computing system onboard the aircraft.

17. A method for weather-based routing of an aircraft, the method comprising:
periodically receiving a timeseries of historic weather data and, in response, determining a current costmap based on the timeseries of historic weather data, wherein the costmap comprises a prediction for a current timestep;
based on a comparison of the at least one candidate route to the current route, determining a set of instructions for aircraft navigation;
presenting the set of instructions to a pilot for validation; and
responsive to pilot validation of the set of instructions, updating the current route and controlling the aircraft based on the set of instructions.

18. The method of claim 17, wherein the current timestep is offset from the timeseries of historic weather data by at least one minute.

19. The method of claim 17, wherein the at least one candidate route is generated with a receding horizon controller based on the costmap.

20. The method of claim 17, wherein the costmap and the candidate route are determined at a computing system onboard the aircraft.
